(19) United States
(12) Patent Application Publication
(10) Pub. No.: US 2024/0032539 A1
(43) Pub. Date: Feb. 1, 2024

(54) CONCENTRATED FUNGICIDE COMPOSITION OF PROTHIOCONAZOLE AND PICOXYTROBIN

(71) Applicant: OURO FINO QUÍMICA S.A., Uberaba (BR)

(72) Inventors: Thais BALBÃO CLEMENTE BUENO DE OLIVEIRA, Uberaba (BR); Roberto ESTÊVÃO BRAGION DE TOLEDO, Uberaba (BR); Gilberto FERNANDO VELHO, Uberaba (BR); Richard FELICIANO, Uberaba (BR); Flavia DE OLIVEIRA BIAZOTTO, Uberaba (BR); Marco Antonio DREBES DA CUNHA, Uberaba (BR)

(21) Appl. No.: 18/024,693

(22) PCT Filed: Feb. 9, 2021
(86) PCT No.: PCT/BR2021/050376

§ 371 Date: Mar. 3, 2023

(30) Foreign Application Priority Data
Sep. 3, 2020 (BR) BR102020018053-3

(51) Int. Cl. A01N 43/40; A01P 3/00; A01N 43/653; A01N 25/30

(52) U.S. Cl. CPC A01N 43/40; A01P 3/00; A01N 43/653; A01N 25/30

(57) ABSTRACT

The present invention relates to a concentrated composition based on the fungicides prothioconazole plus picoxystrobin at high concentrations, comprising a surfactant system plus components in the formulation in association with different concentrations of active ingredients and high loading and picoxystrobin and treatment method using said compositions and formulations in the treatment of Asian rust and other diseases

### FIELD OF THE INVENTION

The present invention relates to concentrated agricultural fungicidal compositions and formulations containing prothioconazole and picoxystrobin and method of treatment using said compositions and formulations in the treatment of Asian rust and other diseases.

### STATE OF ART

Phakopsora pachyrhizi rust constitutes a huge concern for soybean cultivation in Brazil. Known for considerably reducing grain yield, its occurrence has been observed in practically all production regions, changing levels of aggressiveness depending on the climate or local predisposing factors.

Since the epidemic initially developed in the west of Bahia in the 2002/2003 harvest, its presence has already been registered in more than 65% of the production area in South America, and in Brazil, in more than 90% of the area cultivated with soybeans.

Different factors have contributed so that soybean rust continues to cause losses in excess of 23 billion dollars, considering the entire production chain. Some epidemiological parameters have been consistent with the passing of the seasons, highlighting the population evolution of Phakopsora pachyrhizi (initial inoculum) combined with favorable climatic conditions for infection (leaf wetness and mild night temperatures) and dispersion (rain frequency).

Operational difficulties and divergent chemical management criteria make this scenario progressively difficult as each harvest progresses. The growing number of fungicide applications can compromise soybean profitability. In the case of chemical control programs implemented late, or even when weather conditions made the control operations unfeasible, both financial and technical aspects are definitely irreparably compromised.

Another concern is the indebtedness of the sector due to the need for investments, which started since the 2003/4 harvest, both to meet the technological and operational demands, aiming at an adequate fight against the disease. In this particular case, the machine x area relationship, as well as the machine x biological parameters relationship, demand adaptation of the production technology.

If these relationships are not observed, the ineffectiveness of the control will be a reality, affecting the overall profitability of the business. When the financial parameter is compromised, the adoption of correct programs is limited, establishing a technical addiction.

The final result suggests the irreparable compromise of chemical tools and a growing difficulty to obtain productivity compatible with soybean costs. Preventatively applied fungicides have emerged as the most effective strategy for controlling this disease (Hartman et al., 1991).

Longer residual period and better performance of fungicides were obtained by Vitti et al. (2004) due to preventive application of fungicides. Likewise, Oliveira (2004) observed an increase in yield of up to 100% when controlling the disease preventively.

To reduce the risk of damage to the crop, the management strategies recommended in Brazil for this disease are the use of early cycle cultivars, sowing at the beginning of the recommended season, the elimination of voluntary soybean plants, the absence of cultivation of soybean in the off-season through the sanitary vacuum, monitoring of the crop from the beginning of the crop development, the use of fungicides when symptoms appear or preventively, and the use of resistant cultivars, when available.

The application of fungicides in spraying the aerial part of the soybean crop, targeting Asian rust, has been advocated. The active ingredients of fungicides registered for the control of Asian soybean rust belong, for the most part, to chemical groups, organic strobilurins, triazoles and carboxamides.

### Strobilurins

The fungicidal activity of strobilurins is linked to their ability to inhibit mitochondrial respiration by binding to the QO site of cytochrome b (Bartlett et al., 2002). Cytochrome b is part of the bc1 complex, located in the mitochondrial membrane of fungus and other eukaryotes. When QoI fungicides bind, there is a blockage in the transfer of electrons between cytochrome b and cytochrome c1, changing the energy production cycle of the fungus (Bartlett et al., 2002).

Such compounds have high activity against spore germination and at the spore germ tube level (Leinhos et al., 1997). This group of compounds acts in the fungus's energy synthesis, and thus is highly effective in the phases of greater energy demand of fungus development (Bartlett et al., 2002).

The potent effect of strobilurins on spore germination explains the high preventive activity that these fungicides deliver (Bartlett et al., 2002). However, fungicides also inhibit the mycelial growth of fungi, presenting curative and protective properties. Strobilurins can have control failures when positioned curatively or eradicatively, due to the lower probability of reaching the target site of the fungus when in abundant mycelial growth.

### Triazoles

The fungicides DMIs (triazoles) act by inhibiting the biosynthesis of ergosterol, an important substance for maintaining the integrity of the cell membrane of fungi. Reduced availability of ergosterol leads to fungal cell disruption and disruption of mycelial growth (Hewitt, 1998).

Triazoles act efficiently at the mycelial level. The great effectiveness of the mechanism of action of DMIs is in the development of the haustorium and mycelial growth inside the tissues (Buchenauer, 1987) and it is for this reason that DMIs fungicides are attributed a curative action. DMIs do not efficiently affect spore germination and germ tube stage as the pathogen obtains the supply of ergosterol or its precursors from reserves contained in the spores (Hanssler & Kuck, 1987).

Emergence of Prothioconazole from the Group of AMD's

In the period comprising 2013-2015, a new fungicide from the group of DMZ's appeared, protioconazole. From the beginning of monitoring until its launch on the market, prothioconazole has shown the lowest effective concentration values 50 (EC50) in the rust monitoring program.

The introduction of this fungicide on the market was the result of hundreds of experiments, conducted in demonstration areas, in different soy producing regions in Brazil. Prothioconazole was then evaluated in a mixture with a strobilurin (QoI).

The comparison was made with fungicides launched on the market, such as combinations of strobilurins (QoI) and carboxamides (SDHI). As it is a fungicide, composed of an innovative active ingredient with differentiated binding at the fungus's site of action, prothioconazole constituted the new generation in the chemical group of DMZ's, being chemically classified as triazolinthione (Frac classification on mode of action 2014—www.FRAC.info).

The combination prothioconazole+strobilurin (QoI) acts in two ways, the first in the control of Asian soybean rust and the second in the complex of diseases such as target spot (Corynespora cassiicola), powdery mildew (Microsphaera difusa), honeydew (Rhizoctonia solani), anthracnose (Colletotrichum truncatum) and end-of-cycle diseases. Therefore, its use is recommended preventively, in the first application or in the first two, when the use of foliar fungicides is more than two applications. In this way, it is possible to explore well the spectrum of action of this fungicide, starting in a robust way the prevention and control of soybean rust and, consequently, improving the performance of the subsequent fungicide.

### Carboxamides

Carboxamides, succinate dehydrogenase inhibitors (SDHI) is another chemical group recently introduced in the control of Phakopsora pachyrrizi. Complex II is the tricarboxylic acid succinate dehydrogenase (TCA) or Krebs cycle of the fungus.

This cycle catalyzes the oxidation of succinate to fumarate, coupled with the reduction of ubiquinone to ubiquinol. SDHI fungicides bind to complex II subunits and act by breaking the fungus's respiratory cycle (Walter, 2011).

In general, these fungicides have the same characteristics mentioned above for the QoI compounds. It has high spore activity and germ tube formation, a phase in which the fungus demands a lot of metabolic energy.

Thus, they must be necessarily positioned preventively so that they deliver better control performances.

Fungicide application programs must provide effective disease control. The correct control management is a critical component to delay the development of resistant populations, due to the selection pressure exerted by the application of fungicides.

The recommendations of fungicides to control Asian soybean rust should be based on registered products containing strobilurins in combination with triazoles, triazolinthion and/or carboxamides, which should be applied in doses, times and intervals according to the recommendation of the companies holding the registration.

Curatively initiated application programs favor continuous selection pressure and accelerate the development of less sensitive populations of the pathogen and, therefore, should not be used. Good agronomic practices that avoid unnecessary exposure of products to high populations of the pathogen are essential in managing rust control and should be employed, such as: avoiding late planting, giving preference to early-cycle varieties with greater disease tolerance, respecting the void, eliminating voluntary soy plants, avoiding planting second crop soy and monitoring the crop.

In the case of this technical opinion, the fundamentals of the control of Asian soybean rust, consequences of poor control of this disease and the indication of technically grounded directions for a safe control of this disease will be addressed. Therefore, recent works were developed with the objective of evaluating the agronomic efficiency and practicality of the fungicide OFA-T 0143/17 (protioconazol 240 gL−1+picoxystrobin 200 gL−1) to control Asian rust targets (Phakopsora pachyrhizi SYDOW E SYDOW), brown spot (Septoria glycines Hemmi) on soybean crop in different regions of Brazil.

Effect of the Interaction Between Prothioconazole+Picoxystrobin on the Control of Asian Rust (Phakopsora pachyrhizi)

Soybeans stand out as the main grain crop sown in Brazil, occupying the largest planted area and responsible for the largest volume of harvested grains.

One of the major phytosanitary challenges that occur in the various growing regions in Brazil is soybean rust (FAS) caused by Phakopsora pachyrhizi. Until 2001, South America was free from the attack of this pathogen (FREIRE et al., 2008).

From 2001 the disease was found in Paraguay and also in Brazil, becoming a pandemic that brought great challenges to soybean production in the country (YORINORI et al., 2005).

From that date onwards, the pathogen has become highly adapted to environmental conditions and has been causing significant damage uninterruptedly over the years.

Among the most used methods in the management of FAS is the chemical method through the use of fungicides. The main fungicides used for chemical management of the disease belong to the chemical groups of the fungus cell respiration inhibitors, acting on the external quinone in mitochondrial crests (QoIs—Quinone outside Inhibitors), the carbon chain demethylation inhibitors in the synthesis of sterols in cell membranes (DMIs—DeMethylation Inhibitors) and carboxamides became part of this arsenal.

Carboxamides belong to the chemical group of mitochondrial respiration inhibitors, which bind to complex II of the electron transport chain, targeting the enzyme succinate dehydrogenase (SDHI—Succinate DeHydrogenase Inhibitors) (KEON et al., 1991).

All products belonging to these chemical groups act at specific sites in the pathogen's metabolism. In fifteen years of soybean rust in Brazil, we have gone from less than one application of fungicides to close to four applications considered in average terms. Initially, isolated active ingredients were used, evolving to formulated mixtures of different actives and a tank mixture of two or more active ingredients considering different mechanisms of action.

In this context, in the search for management strategies against the pathogen's resistance to fungicides, a new fungicide from the group of DMZ's, protioconazole, appears on the market in the period comprising 2013 to 2015.

From the beginning of monitoring until its launch on the market, this triazole had the lowest effective concentration values 50 (EC50) in the rust monitoring program.

Because it is a fungicide, composed of an innovative active ingredient with differentiated binding at the fungus's site of action, prothioconazole constituted the new generation in the chemical group of DMZ's, being chemically classified as triazolinthione (FRAC classification on mode of action 2014).

That said, the combination of triazole+strobilurin acts in two ways, the first in the control of Asian soybean rust, and the second in the complex of diseases such as target spot (Corynespora cassiicola), powdery mildew (Microsphaera difusa), mela (Rhizoctonia solani), anthracnose (Colletotrichum truncatum) and end-of-cycle diseases.

Therefore, its use is recommended preventively, in the first application or in the first two, when the use of foliar fungicides is more than two applications.

In this way, it is possible to explore well the spectrum of action of this fungicide, starting in a robust way the prevention and control of Asian soybean rust and, consequently, improving the performance of the subsequent fungicide.

Mixtures of fungicides can lead to the occurrence of interactions that can manifest in an additive, antagonistic or synergistic way. Depending on the interaction, gains or losses in disease control can be obtained (TREZZI et al., 2005).

According to Maciel et al. (2009) little is known about the compatibility and effect of mixing different products in agriculture. The synergy between fungicides is entirely desired and can result in a significant increase in disease control (EVENHUIS et al., 1996).

Synergism is the action of two or more compounds in which the total control response of an organism is greater than the sum of the individual components (WAARD, 1987). Hypotheses about the physiological and biochemical mechanisms of synergism involve increased absorption and binding of fungicides to the site of action, action at different locations in the fungal cell and decreased biodegradation (GISI, 1991).

Among the different effects, without a doubt the existence of synergism is advantageous, because it broadens the spectrum of action of fungicides, contributing to the prevention of the emergence of resistance and increasing the efficiency of control.

In this sense, to minimize or avoid the risks involved, studies were carried out on the possible effects of the association between fungicides. The objective of this work was to evaluate the result of the interaction between prothioconazole plus picoxystrobin.

### SUMMARY OF THE INVENTION

The present invention refers to a concentrated composition based on the fungicides prothioconazole plus picoxystrobin in high concentrations, comprising a surfactant system plus components in the formulation in association with different concentrations of active ingredients and high load.

In particular, the invention relates to compositions of prothioconazole plus picoxystrobin with a high load that present reduced losses of fungicides by washing rainwater after application and by drift, deposition and spreading on the leaf surface, greater ease absorption and penetration of fungicides in the leaves, and better translocation in plants, thus promoting greater efficacy in the control of Asian rust and leaf spots in soybean and other diseases in different agricultural crops.

The present invention has as its main objective the achievement of a composition that promotes an increase in the concentration of prothioconazole fungicides plus picoxystrobin to be applied to plants, so that in addition to its effective fungicidal effect and greater speed of control action, also present itself with the objective of reducing the possible processes of loss of active ingredients present in the formulation by rainwater, thus reducing the environmental impact, in addition to minimizing expenses with transportation, storage and, mainly, packaging disposal.

More specifically, combinations comprising different concentrations of prothioconazole+high-load picoxystrobin and a surfactant system were explored, in order to increase the concentration of fungicides, that is, improve their effectiveness and dynamics in plants regarding the control of different diseases in crops, such as Asian soybean rust.

However, the present invention, despite the increased concentration of fungicides in plants, does not compromise the effectiveness, selectivity of soybean, corn and cotton crops, among other crops, in addition to promoting greater safety for farmers, consumers and for the environment.

More specifically, the components of the composition of the present invention are presented in properly balanced proportions resulting in greater agronomic efficiency in the management of Asian rust and leaf spots in soybean, among other diseases in different agricultural crops, as well as crop selectivity conventional and transgenic soybean, corn and cotton, thus contributing to the preservation of the productive potential of these crops.

Additionally, the composition of the present invention also has low toxicity to man and the environment, in addition to providing low production cost.

The present invention also relates to a formulation derived from said composition in the form of a concentrated suspension, in order to obtain in a single package, a ready-made formulation that is dissolved in situ, directly in the water tank suitable for spraying in the field.

More specifically, therefore, the present invention also includes concentrated fungicidal formulations, containing high-load prothioconazole+picoxystrobin and properly balanced components using a surfactant system, said formulation that aims to facilitate the deposition and spread of fungicides on the surface of leaves, absorption and penetration into the plant leaf and translocation in the plant.

Additionally, the present invention also relates to a method of elimination or treatment and control of different diseases in agricultural crops, through the use of formulations derived from said fungicidal composition of the present invention.

### From the Combination of Active Ingredientes

Prothioconazole has as its site of action: Group G1 or C14-demethylase in sterol biosynthesis (erg 11/cyp51)/DM I-fungicides (demethylation inhibitors) (SBI: Class I).

Picoxystrobin has as its action site: Group C3—Complex III: cytochrome bc1 (ubiquinol oxidase) at the Qo/QoI-fungicides site (Extracellular Quinone Inhibitors).

In general, triazole fungicides, a group that includes prothioconazole, has predominant eradicating and antisporulant action with some curative action. Strobirulins, with extracellular action, predominantly act as preventive and curative fungicides.

The analysis of the information indicates that the selection of the two active ingredients is coherent and aligned with the most recent knowledge about the site and mode of action of fungicides. The combination of the two actives in proportion to the concentrations and with the compounded surfactants in the formulation corresponds to the first innovation contained in the developed product.

### The Choice of Prothioconazole

Triazoles have been used to control fungal diseases in humans, animals and agricultural crops in the last four decades, as can be seen in Table 01.

Table 01 summarizes the main information about these compounds obtained from the PPDB portal: Pesticide Properties DataBase maintained by the University of Hertfordshire (https://sitem.herts.ac.uk/aeru/footprint/es/index.htm) which is one of the most widely used and reliable sources of information on crop protection products worldwide.

Only some information that were fundamental for the selection of prothioconazole to compose the innovative formulation of fungicides of the present invention were selected.

TABLE 01
Compiled of some information on triazole fungicides

| | | Solubility | Log | | | |
|---|---|---|---|---|---|---|
| | | in water | Know | | Dissociation | |
| | Introduction | mg/L or | (P | | Constant - | |
| Compound | year | PPM | Log) | Know P | Pka | Classification |
| azaconazole | 1983 | 300 | 2.36 | 229.1 | 3 | Very weak base |
| bromuconazole | 1990 | 48.3 | 3.24 | 1.737.8 | 2.75 | Strong acid |
| cyproconazole | 1986 | 93 | 3.09 | 1.230.3 | Don't aply | No dissociation |
| diphenococonazole | 1988 | 15 | 4.36 | 22.908.7 | 1.07 | Strong acid |
| epoxiconazole | 1993 | 7.1 | 3.3 | 1.995.3 | Don't aply | No dissociation |
| fenbuconazole | 1992 | 2.47 | 3.79 | 6.166.0 | Don't aply | No dissociation |
| fluquinconazole | 1995 | 1.15 | 3.24 | 1.737.8 | 0.9 | Strong acid |
| hexaconazole | 1986 | 18 | 3.9 | 7.943.3 | 2.3 | Strong acid |
| metconazole | 1994 | 30.4 | 3.85 | 7.079.5 | 11.38 | Very weak acid |
| penconazole | 1983 | 73 | 3.72 | 5.248.1 | 1.51 | Very weak base |
| propiconazole | 1980 | 150 | 3.72 | 5.248.1 | 1.09 | Very weak base |
| prothioconazole | 2002 | 22.5 | 2 | 100.0 | 6.9 | Weak acid |
| tebuconazole | 1986 | 36 | 3.7 | 5.011.9 | 5 | Weak acid |
| tetraconazole | 1990 | 156.6 | 3.56 | 3.630.8 | 0.65 | Strong acid |
| triticonazole | 1993 | 9.3 | 3.29 | 1.949.8 | Don't aply | No dissociation |
| uniconazole | 1985 | 8.41 | 3.84 | 6.918.3 | 13.07 | Very weak acid |

The selection of prothioconazole had as theoretical reference the work of Bromilow et al. (1990) originally developed taking herbicides as examples, but whose conclusions are applicable to all organic compounds in plants.

The selection of prothioconazole was made considering, as a matter of priority, the fact that it was introduced in 2002, with no more patents that precluded its use and the Kow of 100, very close to the ideal value for crossing membranes in plants and optimizing translocation via xylem.

Its Pka would also indicate potential translocation by phloem, but the great ease in crossing membranes (conditioned by the Kow of 100) limits this possibility.

However, even not translocating expressively through the phloem, prothioconazole is the triazole with greater potential for movement in plants and greater potential for entry into plant cells, justifying its selection.

Also noteworthy is the fact that prothioconazole is a low-risk product for workers, consumers and the environment. Remember that risk is not synonymous with danger.

The risk depends on both the hazard and the exposure. Exposure, in turn, depends on several factors, including dose, number of applications, time interval between application and harvest, RL50, pesticide dynamics in the plant and in the environment, technology and protection equipment used.

With all this complexity, the question that arises is: is there any risk indicator for the use of pesticides that is accurate, simple to use and easily understandable? So far, the best available option is the Eiq proposed by Kovach et al. (1992).

The use of Eiq to indicate the risk or safety of pesticides is a contemporary global trend, examples being publications by FAO (2008) and Brookes and Barfoot (2017).

This indicator is calculated from a total of 12 characteristics of pesticides: dermal toxicity, chronic toxicity, systemicity, toxicity to fish, leaching potential, potential for movement on the soil surface, toxicity to birds, time to degrade 50% in soil, toxicity to bees, toxicity to beneficial arthropods and time to degrade 50% on plant surface.

The total Eiq is characteristic of each active ingredient and corresponds to the average of three other more specific coefficients calculated from subgroups of the aforementioned characteristics: Eiq Ecological, Eiq for the worker and Eiq for the consumer.

The Eiq values are dimensionless and can be determined for 1 kg of the active ingredient (to compare the safety of different compounds) or per hectare treated (considers the variable effective dose of use). There are applications that do the calculation automatically such as Eiq Calculator (Cornell—CALS, 2018).

The values of Total Eiq, Consumer Eiq, Worker Eiq, Ecological Eiq for 1 kg of prothioconazole are 26.9; 10.5; 13.9 and 55.5 respectively. But the application doses of prothioconazole can be quite low, increasing its safety. Considering a dose of 96 g a.i./ha, a dose compatible with field application doses, the Eiq values would be only 2.58; 1.008; 1.33 and 5.33, also respectively.

In summary, prothioconazole is a compound with a long history of effective and safe use in agriculture, which summarizes physical and chemical characteristics favorable to translocation in plants and with low Eiq values per kg of product or per hectare treated (which it considers the application dose).

The selection of prothioconazole based on the information presented corresponds to the second innovation included in the product developed.

### Choosing Picoxystrobin

The choice of picoxystrobin was more complex and had as a starting point the information presented in Table 02, which has as sources the PPDB portal: Pesticide Properties DataBase maintained by the University of Hertfordshire (https://sitem.herts.ac.uk/aeru/footprint/es/index.htm) and the Pubchem portal maintained by the National Library of Medicine/National Center for Biotechnology Information (https://pubchem.ncbi.nlm.nih.gov/).

The four strobirulins not protected by patents and most commonly used in Brazil and in the world were selected.

The analysis of information indicates that the four compounds have low solubility, are not ionizable and have Kow (or log of Kow) which indicates that they are compounds of low mobility in plants. Therefore, these three characteristics were not relevant in terms of selection.

The first characteristic considered in the decision-making process was exactly the simplest, the molar mass. Picoxystrobin has the lowest molar mass (367.3 g/Mol) indicating that there is a greater number of Mols contained in 1 kg of the compound (2.72).

The effective interaction of fungicides with the action sites (enzymes or receptors) depends on the presence of the compound in “amount” sufficient to cause inhibition. Quantity in this case refers to the number of molecules and not the mass of the molecules.

Substances with lower molar mass can produce a greater number of molecules from the same amount of mass established in g or kg. For example, a given number of grams of picoxystrobin has 11.12% more molecules than the same number of grams of trifloxystrobin/trifloxystrobin.

TABLE 2
Compiled of some information about strobirulins with
fungicidal action.

| Feature | Unit | Azoxystrobin | Picoxystrobin | Pyrclostrobin | Trifloxystrobin |
|---|---|---|---|---|---|
| introduction year | year | 1992 | 2001 | 2000 | 1999 |
| Solubility-water | mg/L or PPM | 6.7 | 3.1 | 1.5 | 0.61 |
| Know or P | dimensionless | 316 | 3981 | 9772 | 31623 |
| Log Know or Log P | dimensionless | 2.5 | 3.6 | 3.99 | 4.5 |
| ionization | pKa or pKb | Non-ionizable | Non-ionizable | Non-ionizable | Non-ionizable |
| Molar mass | g | 403.0 | 367.3 | 387.8 | 408.4 |
| No. of Mol/Kg | | 2.48 | 2.72 | 2.58 | 2.45 |
| Total Equi | Units/Kg | 23.0 | 11.7 | 23.1 | 25.5 |
| Total Equity (%) | Units/Kg | 196.6 | 100.0 | 197.4 | 217.9 |
| Total Equi | Units/Mol | 9.3 | 4.3 | 9.0 | 10.4 |
| Total Equity (%) | Units/Mol | 215.7 | 100.0 | 208.5 | 242.3 |
| RL50 in plants | Days | 7.0 | 6.9 | 4.7 | 9.1 |

The most relevant information in choosing picoxystrobin to compose the innovative product developed were those referring to Eiq. The total Eiq of picoxystrobin expressed per kg was only 11.7.

When the Eiqs of the other strobirulins were expressed as a percentage of this value, the results obtained were 196.6%; 197.4% and 217.9% for azoxystrobin, pyraclostrobin and trifloxystrobin, respectively. Inverting the numerator and denominator, the total picoxystrobin Eiq value expressed as a percentage of the values observed for azoxystrobin, pyraclostrobin and trifloxystrobin were 50.87%; 50.65% and 45.88% with an average reduction of risks for consumers, workers and the environment of 49.13%; 49.35% and 54.12%, respectively.

When the molar mass information is combined with the Eiq information, the greater safety or lower risk associated with the use of picoxystrobin becomes even more evident.

Complementing the information about picoxystrobin, the values of Total Eiq, Consumer Eiq, Worker Eiq, Ecological Eiq for 1 kg of the compound are 11.7; 5.1; 5.1 and 25.0 respectively. But the application doses of picoxystrobin can be quite low, increasing its safety. Considering a dose of 80g a.i./ha, a dose compatible with field application doses, the Eiq values would be only 0.936; 0.408; 0.408 and 2.00, also respectively.

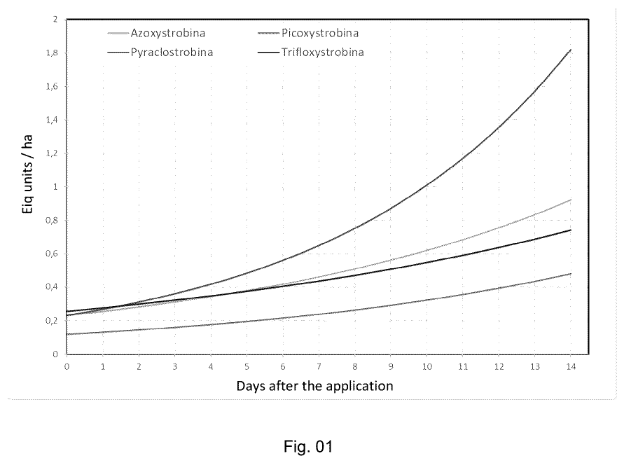

When the Eiq information is articulated with the persistence information in the plant matrix, the information presented in FIG. 1 can be produced, which was prepared predicting the presence of 10 g of the different compounds in the plant matrix from 0 to 14 days after the application.

For example, the comparison of results for picoxystrobin and trifloxystrobin at 14 days after application indicates that, even being more persistent, trifloxystrobin required 35.54% more Eiq units so that 10 g of the compound remained in the plant matrix at 14 days after application.

In all other conditions, the advantages of using picoxystrobin were even more evident, as illustrated in FIG. 1 that describes the Units of Eiq/ha so that 10 g of different strobirulins occur in the plant matrix as a function of the number of days after application.

In summary, picoxystrobin is a compound with a long history of effective and safe use in agriculture, with lower molar mass than other competitors and, above all, with very low Eiq values per kg of product or per hectare treated (considering the application dose). The selection of picoxystrobin based on the information presented corresponds to the third innovation included in the developed product.

The most critical step in the development of the present invention was the selection of assets, as presented above. Based on this definition and having sustainability and risk reduction as the main objectives, the main points for improvement that should be incorporated into the new product were identified:
1) increased concentration of active ingredients in the formulation, reducing consumption of raw materials and transport costs;
2) use of safer raw materials in toxicological and environmental terms;
3) development of stable formulations during storage and transport;
4) increased deposition with reduced losses due to drift;
5) development of formulations with dynamics and persistence of each of the active ingredients more suitable for controlling pathogens; and
6) high efficacy in comparative tests under practical conditions of use.

The six items mentioned follow both logical and chronological order.

In fact, the circuit they represented was covered several times, obtaining new information and continuously improving the prototypes produced.

Dozens of experimental formulations were developed and evaluated until it was possible to reach the definitive formulation that allows achieving, simultaneously, all the established objectives.

Combinations of a surfactant system together with other components comprising a fixing agent and a flow agent for use in fungicidal formulations comprising compositions of prothioconazole plus picoxystrobin with high loading have been developed.

More specifically, the components of the composition of the present invention, are presented in properly balanced proportions and with this reduces losses of fungicides by washing rainwater after application and by drift, deposition and spreading on the leaf surface, making it easier absorption and penetration of fungicides in the leaves, and better translocation in the plants, also contributing to the application by spraying provided, less evaporation in the path from the spray tip to the biological target, formation of liquid films on the leaf surfaces, by coalescence of the droplets, promoting thus greater effectiveness in the control of Asian rust and leaf spots in soybean and other diseases in different agricultural crops.

The combination of a properly balanced surfactant system, a fixing agent and a flow agent used in this fungicide consists of a set of neutralized sulfated polyarylphenol ethoxylated surfactant and acrylic copolymer surfactant, polyvinylpyrrolidone fixing agent and silicon dioxide flow agent.

Silicon dioxide, increases the stability of the formulated product, allows the incorporation with homogeneity of components in the formulation, improving the fluidity properties of the formulation.

Polyvinylpyrrolidone is a water-soluble polymer by multifunctional chains, inert and has properties that provide a tough, flexible film, and acts as an adhesion agent, binding agent, dispersing agent, rheological modifier and a crosslinking agent.

The acrylic copolymer is a high-performance polymeric dispersant, developed to overcome the challenges related to flocculation and sedimentation, enables the incorporation of high levels of solids charge, prevents flocculation, due to the presence of a spherical barrier, prevents formation of crystals, optimizes fluidity.

This dispersant improves the stability of the emulsion or dispersion, lowers foaming, is stable in systems containing electrolytes, being a nonionic surfactant that has excellent compatibility with active ingredients.

Neutralized sulfated ethoxylated polyarylphenol is used as emulsifier and dispersant. As an emulsifying agent it increases kinetic stability making the formulation stable and homogeneous and acts as a dispersant and promotes the uniform separation of extremely fine solid particles from the fungicide, making the formulation stable.

TABLE 3
Examples of herbicide formulations containing concentrated agricultural fungicides containing prothioconazole and picoxystrobin.

| | Formulations | | | | | | |
|---|---|---|---|---|---|---|---|
| | F1 | F2 | F3 | F4 | F5 | F6 | |
| Formulation components | % m/m | % m/m | % m/m | % m/m | % m/m | % m/m | Function |
| Technical Prothioconazole | 19.45-21.93 | 19.45-21.93 | 19.45-21.93 | 19.45-21.93 | 19.45-21.93 | 19.45-21.93 | Active |
| 100% (RS)-2-[2-(1- | | | | | | | ingredient |
| chlorocyclopropyl)-3-(2- | | | | | | | |
| chlorophenyl)-2- | | | | | | | |
| hydroxypropyl]-2.4- | | | | | | | |
| dihydro1,2,4-triazole-3-thione | | | | | | | |
| Technical Picoxystrobin | 16.21-18.28 | 16.21-18.28 | 16.21-18.28 | 16.21-18.28 | 16.21-18.28 | 16.21-18.28 | Active |
| 100% (E)-3-methoxy-2-{2-[6- | | | | | | | ingredient |
| (trifluoromethyl)-2- | | | | | | | |
| pyridyloxymethyl]phenyl}methyl | | | | | | | |
| acrylate | | | | | | | |
| Propylene glycol | 4.00-10.00 | 4.00-10.00 | 4.00-10.00 | 4.00-10.00 | 4.00-10.00 | 4.00-10.00 | Antifreeze |
| Poly(oxy-1,2-ethanediyl), | — | — | — | 2.00-7.00 | — | — | Surfactant |
| alpha-sulfo-omega-(2,4,6- | | | | | | | |
| tris(1- | | | | | | | |
| phenylethyl)phenoxy)ammonium | | | | | | | |
| salt | | | | | | | |
| Methyl methacrylate- | — | — | — | 2.00-7.00 | — | 2.00-7.0 | Surfactant |
| methacrylic acid methacrylate | | | | | | | |
| copolymer | | | | | | | |
| Aromatic sulfated | 2.00-7.0 | — | — | — | — | — | Surfactant |
| condensation product, | | | | | | | |
| sodium salt | | | | | | | |
| Dodecanol, ethoxylated | 2.00-7.00 | — | — | — | 2.00-7.00 | — | Surfactant |
| monoether with sulfuric acid | | | | | | | |
| Polyethylene polypropylene | — | 2.00-7.00 | 2.00-7.00 | — | — | — | Surfactant |
| glycol monobutyl ether | | | | | | | |
| Phosphated polyoxyethylene | — | 2.00-7.00 | — | — | — | 2.00-7.00 | Surfactant |
| trisylphenol, potassium salt | | | | | | | |
| Triethanolamine compound | | | 2.00-7.00 | — | 2.00-7.00 | — | Surfactant |
| with poly(oxyethylene) | | | | | | | |
| tristyrylphenol ether | | | | | | | |
| phosphate | | | | | | | |
| Polyvinylpyrrolidone | 0.01-1.00 | 0.01-1.00 | 0.01-1.00 | 0.01-1.00 | 0.01-1.00 | 0.01-1.00 | Fixing agent |
| Precipitated silica gel without | 0.10-2.0 | 0.10-2.00 | 0.10-2.00 | 0.10-2.00 | 0.10-2.00 | 0.10-2.00 | Fluidity agent |
| crystals | | | | | | | |
| Poly(dimethylsiloxane) | 0.50-3.00 | 0.50-3.00 | 0.50-3.00 | 0.50-3.00 | 0.50-3.00 | 0.50-3.00 | Defoamer |
| 1,2-benzisothiazolin-3-one | 0.10-0.50 | 0.10-0.50 | 0.10-0.50 | 0.10-0.50 | 0.10-0.50 | 0.10-0.50 | Biocide |
| Xanthan Gum | 0.01-0.30 | 0.01-0.30 | 0.01-0.30 | 0.01-0.30 | 0.01-0.30 | 0.01-0.30 | Thickener |
| Water | 29.00-56.00 | 29.00-56.00 | 29.00-56.00 | 29.00-56.00 | 29.00-56.00 | 29.00-56.00 | Solvent |

TABLE 4
Example composition of the fungicide of the present
invention called prototype 4.

| | | | CAS | Concentration |
|---|---|---|---|---|
| Occupation | | Components | Number | (% m/m) |
| Active | Fungicide | Technical 100% Prothioconazole | 178928- | 19.45-21.93 |
| ingredient | prothicoazole | (RS)-2-[2-(1-chlorocyclopropyl)-3- | 70-6 | |
| | | (2-chlorophenyl)-2-hydroxypropyl]- | | |
| | | 2,4-dihydro1,2,4-triazole-3-thione | | |
| Active | Fungicide | Picoxystrobin Technique 100% (E)- | 117428- | 16.21-18.28 |
| ingredient | picoxystrobin | 3-methoxy-2-{2-[6-(trifluoromethyl)- | 22-5 | |
| | | 2-pyridyloxymethyl]phenyl}methyl | | |
| | | acrylate | | |
| Antifreeze | | Propylene glycol | 57-55-6 | 4.00-10.00 |
| Surfactant | Neutralized sulfated | Poly(oxy-1,2-ethanediyl), alpha- | 119432- | 2.00-7.00 |
| | ethoxylated | sulfo-omega-(2,4,6-tris(1- | 41-6 | |
| | polyarylphenol | phenylethyl)phenoxy)ammonium | | |
| | | salt | | |
| Surfactant | Acrylic copolymer | Methyl methacrylate-methacrylic | 119724- | 2.00-7.00 |
| | | acid methacrylate copolymer | 54-8 | |
| Fixing agent | Polyvinylpyrrolidone | Polyvinylpyrrolidone | 9003-39- | 0.01-1.00 |
| | | | 8 | |
| Fluidity agent | Silicon dioxide | Precipitated silica gel without | 112926- | 0.10-2.00 |
| | | crystals | 00-8 | |
| Defoamer | | Poly(dimethylsiloxane) | 63148- | 0.50-3.00 |
| | | | 62-9 | |
| Biocide | | 1,2-benzisothiazolin-3-one | 2634-33- | 0.10-0.50 |
| | | | 5 | |
| Thickener | | Xanthan Gum | 11138- | 0.01-0.30 |
| | | | 66-2 | |
| Solvent | | Water | 7732-18- | 29.00-56.00 |
| | | | 5 | |

The compositions developed in this invention containing high-load prothioconazole and picoxystroin, in proper balance of concentration ranges associated with the surfactant system along with other components comprising a fixing agent and flow agent, as mentioned above, promote greater efficiency in the management of diseases and greater safety to the environment, as they reduce fungicide losses by washing rainwater after application and by drift, deposition and spreading on the leaf surface, easier absorption and penetration of fungicides in the leaves, and better translocation in plants, also contributing to the spray application provided, less evaporation in the path from the spray tip to the biological target, formation of liquid films on the leaf surfaces, by coalescence of the drops, thus promoting greater effectiveness in the control of Asian-rust and leaf spots in soybean and other diseases in different cultures agricultural.

Within this context, it is important to emphasize that drift and deposition are opposite phenomena. Drift indicates losses during the application process and deposition indicates how much of the applied product effectively deposited on the target (soybean plants in this case).

Today, drift is identified as the main cause of losses and environmental contamination related to the application of pesticides.

Reducing drift is essential to increase deposition and effectiveness, reduce environmental contamination and, by reducing the amount of droplets in suspension, reduce the exposure of workers involved in the application.

When flat targets such as the ground surface are used, making a mass balance of the application by accurately determining the deposition and drift is relatively simple.

However, in plants, with great variation in architecture, leaf area and morphology, performing a mass balance is not possible and the most appropriate procedure is to measure the deposition or deposit of the applied compounds per unit of area or mass of the plant.

It is very important to conduct the evaluations under conditions representative of the practical application conditions in terms of application technology and application solution characteristics.

In this case, the information produced in the comparative dynamics studies conducted in order to compare the prototypes of formulations with each other and with the main commercial standard were used.

The applications were made under controlled conditions with a speed of 1 m/s, using XR 110.02 tips, pressure of 2 Bar and application rate of 200L/ha, temperature of 28° C. and relative humidity of 56%.

The application was made with experimental equipment of high precision that allows the control of the mentioned operational variables. The study was conducted using stage V6 soybean plants as a target, with five replicates for each active ingredient.

The treatments were:
1) application of prototype 4 at a dose of 0.4 L ha−1, conditioning doses of the compounds prothioconazole and picoxystrobin of 96 and 80 g of ai ha−1; and
2) treatment with the commercial standard Fox, at a dose of 0.4 L ha−1, conditioning doses of the compounds prothioconazole and trifloxystrobin of 70 and 60 g ha−1.

All treatments received the addition of Aureo adjuvant at a concentration of 0.25% (equivalent to 0.5 L ha−1).

The determination of the contents of the compounds prothioconazole, picoxystrobin and trifloxystrobin was carried out using the LC/MS-MS technique after maceration of the plants at low temperature (in liquid nitrogen), lyophilization to eliminate moisture and extraction with appropriate solvents.

The results were initially represented in ng of compounds/g of lyophilized sheets. As the application rates of the compounds were different between treatments, the data were corrected (divided) by the application rates expressed in g/ha.

In summary, it was determined what the result provided by the application of 1 g/ha of each of the compounds in terms of the amount present in a gram of lyophilized soybean leaf.

To simplify the analysis, the results were expressed as a percentage of the values obtained in the standard treatment in which the mixture of prothioconazole and trifloxystrobin was applied.

In all analyzes conducted, the concentrations of both prothioconazole and its main metabolite desthioprothioconazole were determined and the values presented refer to the sum of the concentrations of the two compounds.

Table 05 shows the results obtained and information on the statistical analysis of the data. When the concentration information of the active ingredients expressed in “(ng/g)/(g/ha)” is compared, the values are higher in the treatment that corresponds to Prototype 4. When the values of this treatment are converted into a percentage of the values found in the standard treatment “(100×P4/TP)”, it is evident that the deposition estimates made from the concentrations of the fungicide prothioconazole and its metabolite, or of the strobirulins (picoxystrobin or trifloxystrobin) presented similar values.

The mean depositions observed in the treatment with Prototype 4 corresponded to 121.82 and 121.79 of the mean values found in the standard treatment.

In turn, the average between these two values is 121.80 indicating that in the treatment with Prototype 4 there was a 21.80% higher deposition of application solution.

TABLE 6
Prototype 4 deposition information when compared to the
commercial standard

| | (ng/g)/(g/ha) | | | | |
|---|---|---|---|---|---|
| | Prototype | Standard | 100 × | Sta- | α |
| | 4 | Treatment | P4/ | tistics | (Pr > |
| Compounds | (P4) | (TP) | TP | Values | F) |
| Prothioconazole + | 263.3 | 216.1 | 121.82 | | |
| desthioprothioconazole | | | | | |
| Picoxystrobin or | 649.8 | 533.6 | 121.79 | | |
| Trifloxystrobin | | | | | |
| Average | | | 121.80 | | |
| F of treatments | | | | 21.77 | 0.0095 |
| F of repetitions | | | | 7.20 | 0.0410 |
| Coefficient of | | | | 6.66 | |
| variation | | | | | |

In terms of statistical analysis, we chose to present the level of significance at which the contrast (or the comparison) was significant involving the treatments corresponding to Prototype 4 and the Standard Treatment.

The probability that the comparison was significant (α or Pr>F) represents the probability of occurrence of type 1 experimental errors or the probability of error when admitting that the compared means are different.

To represent the probabilities in percentages, the values presented in Table 06 must be multiplied by 100. In summary, the comparison between the two treatments was significant at the probability level of 0.0095 (or 0.95%) indicating a effective treatment superiority corresponding to Prototype 4 with 21.80% higher application solution deposition. We emphasize that greater deposition contributes to efficiency and reduces drift losses and risks associated with suspended drops.

Reducing losses in the application process, with increased deposition, is essential to maximize efficiency and minimize for workers and the environment. The development of a formulation with greater deposition corresponds to the fourth innovation included in the developed product.

Development of Formulations with Dynamics and Persistence of Each of the Active Ingredients Most Suitable for Controlling Pathogens

The development of prototype formulations was preceded by preliminary tests of dynamics, persistence and metabolization of the active ingredients considered.

Specific tests were conducted to determine the rate of degradation of the compounds on the surface of the leaves and inside them. A very relevant observation is that internal metabolization is faster than decomposition on the leaf surface.

If, on the one hand, the actives need to penetrate the sheet, on the other, they will be decomposed more quickly when absorbed. Keeping the compounds on the surface of the sheet is a good strategy to allow a controlled process of absorption and degradation, but it is necessary to develop technologies so that the compounds are not decomposed by physical processes, especially photolysis, and to reduce the loading by rain water.

As all prototypes were made containing the two active ingredients (protioconazole and picoxystrobin), technologies were developed to protect and control the release and absorption for each of the actives.

As already discussed, technologies have also been developed to reduce drift and increase deposition. All of these technologies were continuously evaluated and progressively improved and combined in Prototype 4.

The results that will be presented in Tables 05 to 10 were obtained in the final validation test of the developed concepts. It was in this essay that the deposition information discussed above was obtained.

Therefore, the same variables, methods and conditions already described in the deposition study were used. However, in the deposition study, only the information obtained one day after application was presented and the deposition was determined considering the averages observed for the two actives and the total contents observed (internally and externally to the leaves).

In this topic that deals with the dynamics of the experimental formulation against the commercial standard, the information obtained for each of the active ingredients at 01 and 07 days after application, internally and externally to the leaves, will be presented.

The main objective of working with the two periods was to prove that the release and absorption control technologies and photolysis reduction incorporated in the experimental formulation would be effective and would promote a gradual absorption of the actives allowing to obtain higher concentrations of the compounds in the leaves of the culture, at 07 days after application.

In order to achieve these objectives, specific experimental methods were developed to expose the treated plants to full solar radiation during the periods considered.

The treated plants were subjected to specific extraction processes to quantify the active ingredients internally and on the surface of the leaves.

In Tables 07 to 12, the external contents (on the surface of the leaves), internal contents (absorbed part of the compounds) and total contents (sum of the external and internal contents) are presented.

Similar to what was done for the deposition results, the contents were converted to “(ng compound/g lyophilized sheet)/(g a.i./ha)”.

This procedure was essential to enable the comparison of the contents of the evaluated compounds, considering that the application rates were different between treatments.

Returning to the information already presented, the application of prototype 4 at a dose of 0.4 L ha−1 conditioned doses of the compounds prothioconazole and picoxystrobin of 96 and 80 g of ai ha−1 while the application of the commercial standard Fox, in dose of 0.4 L ha−1 conditioned doses of the compounds prothioconazole and trifloxystrobin of 70 and 60 g ha−1, respectively. The study was conducted with five replications and 30 treatments, and only the information about the treatments that correspond to Prototype 4 and the Fox commercial standard in the two evaluation periods will be presented.

All treatments received the addition of Aureo adjuvant at a concentration of 0.25% (equivalent to 0.5 L ha−1).

The entire development process required more than a hundred treatments in its various stages, having been conducted specific studies of absorption, metabolism, photolysis, rate of degradation internally and externally in the leaf, phytotoxication (when present) and to evaluate the effects of rainwater on the removal and transport of prothioconazole and picoxystrobin applied to plants.

In Tables 07 to 09, information about prothioconazole is presented. It is important to highlight that the levels presented refer to the levels of prothioconazole itself plus the levels of its main metabolite, desthioprothioconazole.

This procedure proved to be essential to conduct studies of dynamics and mass balance of high precision. The use of photoprotective technologies that allowed the progressive absorption of the compound was effective.

On the first day after application, the internal contents of prothioconazole were a little lower than those observed in the standard treatment (62.14%) but the external contents were much higher (601.77%).

Considering the external and internal contents, the total contents of prothioconazole were 21.82% higher (100×P4/TP =121.82) in the treatment with application of Prototype 4 as a consequence of the greater deposition observed with the use of this prototype.

The most relevant results were observed at 07 days after application in which the relative contents of external, internal and total prothioconazole in the treatment with prototype 4 corresponded to 493.99%, 189.77% and 195.66% of the values observed in standard treatment.

After seven days of exposure to decomposition processes, especially photolysis, the technologies incorporated in Prototype 4 were effective in promoting a progressive absorption and protecting the prothioconazole and this is the fifth innovation of the developed formulation.

In Tables 10 to 12, the information for picoxystrobin is presented. The data indicate exactly the same pattern of behavior observed for prothioconazole but with smaller differences between treatments.

At 07 days after application, the relative contents of picoxystrobin externally, internally and total in the treatment with prototype 4 corresponded to 113.51%, 118.7% and 116.90% of the values observed in the standard treatment.

It is important to highlight that the RL50 information presented in Table 01 indicates that, under similar conditions, trifloxystrobin is more persistent in plants than picoxystrobin, making the results obtained with the technologies incorporated in Prototype 4 even more relevant.

By making the absorption progressive and photoprotecting trifloxystrobin, it was possible to maintain picoxystrobin for longer and higher levels in soybean leaves and this is the sixth innovation of the developed formulation.

TABLE 7
External prothioconazole contents at 01 and 07 days after
treatment and results of statistical analysis of data

| | Average concentrations in (ng/g)/g/ha) | |
|---|---|---|
| Treatment | 1 DAT | 7 DAT |
| Prototype 4 (P4) | 143.83 | 4.85 |
| Standard Treatment (TP) | 23.90 | 0.98 |
| 100 × P4/TP | 601.77 | 493.99 |
| F of Treatments | 1232.104 | 17.522 |
| α(Pr > F) | 0.000 | 0.014 |
| F of Repetitions | 4.725 | 1.485 |
| α(Pr > F) | 0.081 | 0.356 |
| Coefficient of variation (%) | 6.441 | 50.109 |

TABLE 8
Internal prothioconazole contents at 01 and 07 days after
treatment and results of the statistical analysis of the data

| | Average concentrations in (ng/g)/g/ha) | |
|---|---|---|
| Treatment | 1 DAT | 7 DAT |
| Prototype 4 (P4) | 119.45 | 94.49 |
| Standard Treatment (TP) | 192.23 | 49.79 |
| 100 × P4/TP | 62.14 | 189.77 |
| F of Treatments | 19.683 | 9.648 |
| α(Pr > F) | 0.011 | 0.036 |
| F of Repetitions | 4.417 | 1.427 |
| α(Pr > F) | 0.090 | 0.370 |
| Coefficient of variation (%) | 16.643 | 31.541 |

TABLE 9
Total prothioconazole contents at 01 and 07 days after
treatment and results of statistical analysis of data

| | Average concentrations in (ng/g)/g/ha) | |
|---|---|---|
| Treatment | 1 DAT | 7 DAT |
| Prototype 4 (P4) | 263.28 | 99.34 |
| Standard Treatment (TP) | 216.13 | 50.77 |
| 100 × P4/TP | 121.82 | 195.66 |
| F of Treatments | 6.344 | 10.610 |
| α(Pr > F) | 0.065 | 0.031 |
| 1,471F of Repetitions | 3.255 | 1.471 |
| α(Pr > F) | 0.140 | 0.359 |
| Coefficient of variation (%) | 12.348 | 31.412 |

TABLE 10
External contents of picoxystrobin (Prototype 4) or
trifloxystrobin (Standard Treatment) at 01 and 07 days after treatment and
results of the statistical analysis of the data

| | Average concentrations in (ng/g)/g/ha) | |
|---|---|---|
| Treatment | 1 DAT | 7 DAT |
| Prototype 4 (P4) | 364.55 | 43.65 |
| Standard Treatment (TP) | 219.72 | 38.45 |
| 100 × P4/TP | 165.92 | 113.51 |
| F of Treatments | 4.864 | 0.433 |
| α(Pr > F) | 0.092 | 0.547 |
| 1,471F of Repetitions | 3.026 | 0.123 |
| α(Pr > F) | 0.154 | 0.967 |
| Coefficient of variation (%) | 35.543 | 30.408 |

TABLE 11
Internal contents of picoxystrobin (Prototype 4) or
trifloxystrobin (Standard Treatment) at 01 and 07 days after treatment and
results of the statistical analysis of the data

| | Average concentrations in (ng/g)/g/ha) | |
|---|---|---|
| Treatment | 1 DAT | 7 DAT |
| Prototype 4 (P4) | 285.28 | 112.70 |
| Standard Treatment (TP) | 313.87 | 95.29 |
| 100 × P4/TP | 90.89 | 118.27 |
| F of Treatments | 1.930 | 1.349 |
| α(Pr > F) | 0.237 | 0.310 |
| 1,471F of Repetitions | 4.530 | 1.594 |
| α(Pr > F) | 0.086 | 0.331 |
| Coefficient of variation (%) | 10.862 | 22.793 |

TABLE 12
Total contents of picoxystrobin (Prototype 4) or
trifloxystrobin (Standard Treatment) at 01 and 07 days after treatment and
results of the statistical analysis of the data

| | Average concentrations in (ng/g)/g/ha) | |
|---|---|---|
| Treatment | 1 DAT | 7 DAT |
| Prototype 4 (P4) | 649.83 | 156.35 |
| Standard Treatment (TP) | 533.59 | 133.74 |
| 100 × P4/TP | 121.79 | 116.90 |
| F of Treatments | 3.651 | 1.134 |
| α(Pr > F) | 0.129 | 0.347 |
| 1,471F of Repetitions | 2.698 | 0.799 |
| α(Pr > F) | 0.180 | 0.583 |
| Coefficient of variation (%) | 16.256 | 23.140 |

### Test 1

### Material and Methods

Experiments were conducted in the municipality of Rio Verde/GO, at the Experimental Station Fazenda Água Mansa—MRE Agropesquisa, Rodovia BR 060— Sentido Jataí 10 km and at the State University of Northern Paraná—UENP, Rodovia BR 369 km 54—Vila Maria, municipality of Bandeirantes/PR.

The statistical design used was randomized blocks with four blocks of nine treatments, with a control given in table 13.

TABLE 13
Doses of commercial product/ha, active ingredient in
grams/ha and syrup volume/ha

| | Dose | Dose | Syrup volume |
|---|---|---|---|
| Treatments | (L p · c · ha⁻¹) | (g i · a · ha⁻¹) | (L · ha⁻¹) |
| 1-Witness | — | — | — |
| 2-OFA-E-0088/16* | 0.6 | 150 | 100 |
| 3-OFA-E-0088/16* | 0.8 | 200 | 100 |
| 4-OFA-E-0087/16 | 0.7 | 175 | 100 |
| 5-OFA-E-0087/16 | 0.8 | 200 | 100 |
| 6-OFA-E-0087/16 | 0.96 | 240 | 100 |
| 7-OFA-T 0143/17* | 0.7 + 0.6 | 175 + 150 | 100 |
| 8-OFA-T 0143/17* | 0.8 + 0.8 | 200 + 200 | 100 |
| 9-OFA-T 0143/17* | 0.96 + 0.8 | 240 + 200 | 100 |

¹ OFA-E-0088/16 (Picoxystrobin 250 g · L).
² OFA-E-0087/16 (Prothioconazole 250 g · L).
³ OFA-T0143/17(Prothioconazole + Picoxystrobin).
⁴ Methylated soybean oil was added 0.25% v/v.

The size of the plot used in the test was 15.0 m2, with an applied area of 15.0 m2, however, at the time of evaluation, 1 meter at the beginning and end of the plot and 0.5 meters of each was disregarded. side, making a useful area of 6.0 m2.

The population density of the crop was approximately 408 thousand seeds per hectare, with a spacing of 0.49 m between rows and 5.0 cm between plants.

The applications (two) were carried out by means of a CO2 pressurized back sprayer, equipped with six empty cone-type spray tips, TXVK 8, spaced at 0.50 m, working at a constant pressure of 3.0 kgf/cm².

The disease severity assessments were performed at 7, 14, 21 and 28 days after the appearance of the first pustules in the control (latent period).

The severity assessment considered the percentage of tissue injured by the pathogen, assigning visual notes with the aid of a diagrammatic scale (Godoy et al., 2006).

From the severity data, the area under the disease progress curve (AUDPC) was calculated according to Campbell & Madden (1990) by the formula:

$$AACPD = {\sum }_{i}^{n - 1} [ ( {x}_{i} + {x}_{i} + 1 ) / 2 * ( {t}_{i} + 1 - {t}_{i} ) ]$$

where, n is the number of assessments, x is the proportion of the disease and (ti+1−ti) is the interval between assessments. And the control efficiency of treatments based on Abbot's formula (1925) as described below.

%EF=(N1−N2)×100

N1

on what:
%EF =Percentage of Efficiency
N1=Infestation in the control plot
N2=Infestation in the treated plot

The effect of the interaction between fungicides was calculated according to the methodology proposed by Colby (1969). This method calculates the expected control of the association, which in comparison with the observed control makes it possible to make inferences about the type of interaction. The Expected control (E) for the combination between two fungicides can be calculated in accordance with Gowing (1960), as follows:

$$E = X + \frac{[ Y ( 100 - X ) ]}{100}$$

### Where:

X=percentage of fungicide X isolated control (QoI)
Y=percentage of isolated Y fungicide control (DMI)
When the observed control is greater than expected, the combination is synergistic, when observed less than expected, it is antagonistic, and when observed and expected are equal, the combination is additive.

### Results and Discussion

Through the data in Table 14 it was observed that the association of the fungicide OFA-T 0143/17 (Prothioconazol+Picoxystrobin) at the concentration of 240 gL−1+200 gL−1 resulted in a synergistic interaction throughout the period evaluation, that is, the observed efficacy was greater than expected with the addition of both.

TABLE 14
Additive, synergistic, antagonistic effect of OFA-T
0143/2017 (prothioconazole 240 g · L-1 + picoxystrobin 200 g · L-1)
in the control of Asian rust (Phakopsora pachyrhizi) in soybean crop.

| Concentrations | 7 DAA | 14 DAA | 21 DAA | 28 DAA |
|---|---|---|---|---|
| Expected effect | 58.86¹ | 68.66 | 64.68 | 44.31 |
| 175 + 150² | | | | |
| Observed effect | 55.07 | 59.21 | 55.84 | 44.39 |
| 175 + 150 | | | | |
| Interaction | ANTAGONISM | | | ADDITIVE |
| Expected effect | 68.88 | 78.38 | 74.07 | 51.82 |
| 200 + 200 | | | | |
| Observed effect | 67.77 | 72.88 | 68.73 | 55.24 |
| 200 + 200 | | | | |
| Interaction | | ANTAGONISM | | SYNERGISM |
| Expected effect | 73.35 | 84.04 | 80.27 | 57.23 |
| 240 + 200 | | | | |
| Observed effect | 80.68 | 86.76 | 81.82 | 65.77 |
| 240 + 200 | | | | |

| | |
|---|---|
| Interaction | SYNERGISM |

¹(%) Efficiency using the equation proposed by Abbott.
²Prothioconazole + Picoxystrobin concentrations.
³DAA (days after application).

On the other hand, the interaction in other concentrations showed an additive and/or antagonistic effect, in which the association has less control than the sum of its individual effects. In this way, it was noticed that the erroneous concentration of the mixture hinders the performance of the fungicide. According to Gisi et al., (1985) when the percentage of control of fungicides applied alone is high (>70%), the determination of synergy factors between them is compromised. Lindner et al. (1994) state that the interaction between fungicides can be better compared when individual efficacies are not very high and that when one or both are greater than 70%, the analysis may not efficiently define the synergistic effect. Thus, it is known that the isolated performances of strobiulurins are not satisfactory in controlling FAS. Thus, the association of OFA-T 0143/2017 (prothioconazole 240 g.L−1+picoxystrobin 200 g.L−1) increases the residual and control of Asian soybean rust. It is important to emphasize that combinations of two or more modes of action must be complementary, that is, acting on completely different action sites in the development of the fungus.

### Conclusion

To reduce the risk of damage to the soybean crop, the management strategies recommended for this disease are to reduce the selection pressure for resistance to the fungus, avoid performing sequential applications and curatively. The control of Asian rust must always be preventive, as it is an aggressive pathogen. Thus, the association of OFA-T 0143/2017 (prothioconazole 240 g.L−1+picoxystrobin 200 g.L−1) increases the residual and control of Asian soybean rust.

### Test 2

### Material and Methods

Six studies were conducted in the states of São Paulo, Paraná and Goias with the aim of evaluating the product OFA-T 0143/2017 (protioconazol 240 gL−1+picoxystrobin 200 gL−1) to control the targets of Asian rust Phakopsora pachyrhizi SYDOW AND SYDOW and brown spot Septoria glycines Hemmi, in soybean [Glycine max (L.) Merrill], between November 2018 and March 2019, as shown in Table 15.

TABLE 15
Summary of reports on agronomic efficiency and
practicality

| Nº | STUDY Nº | TITLE | CULTURE |
|---|---|---|---|
| 1 | 00419.6.1- | Evaluation of OFA-T 0143/2017 | Soy |
| | GO- | (Prothioconazole 240 | |
| | 2019-E | g · L-1 + Picoxystrobin 200 g · L-1) | |
| | | in the control of Asian | |
| | | rust Phakopsora pachyrhizi | |
| | | SYDOW AND SYDOW in | |
| | | soybean [Glycine max (L.) Merrill]. | |
| 2 | 00419.7.2- | Evaluation of OFA-T 0143/2017 | Soy |
| | PR- | (Prothioconazole 240 | |
| | 2019-E | g · L-1 + Picoxystrobin 200 g · L-1) | |
| | | in the control of Asian | |
| | | rust Phakopsora pachyrhizi | |
| | | SYDOW AND SYDOW in | |
| | | soybean [Glycine max (L.) Merrill]. | |
| 3 | 00419.10.3- | Evaluation of OFA-T 0143/2017 | Soy |
| | SP- | (Prothioconazole 240 | |
| | 2019-E | g · L-1 + Picoxystrobin 200 g · L-1) | |
| | | in the control of Asian | |
| | | rust Phakopsora pachyrhizi | |
| | | SYDOW AND SYDOW in | |
| | | soybean [Glycine max (L.) Merrill]. | |
| 4 | 00419.7.3- | Evaluation of OFA-T 0143/17 | Soy |
| | PR- | (Protioconazol 240 g · L-1 + | |
| | 2019-E | Picoxystrobin 200 g · L-1) | |
| | | in the control of brown spot | |
| | | Septoria glycines Hemmi in | |
| | | soybean [Glycine max (L.) | |
| | | Merrill] | |
| 5 | 00419.10.2- | Evaluation of OFA-T 0143/17 | Soy |
| | SP- | (Protioconazol 240 g · L-1 + | |
| | 2018-E | Picoxystrobin 200 g · L-1) | |
| | | in the control of brown spot | |
| | | Septoria glycines Hemmi | |
| | | in soybean [Glycine max (L.) | |
| | | Merrill] | |
| 6 | 00419.7.1- | Evaluation of OFA-T 0143/17 | Soy |
| | PR | (Protioconazol 240 g · L-1 + | |
| | 2019-E | Picoxystrobin 200 g · L-1) | |
| | | in the control of brown spot | |
| | | Septoria glycines Hemmi in | |
| | | soybean [Glycine max (L.) | |
| | | Merrill] | |

The statistical design used was randomized blocks with four blocks of seven treatments, with a control given in table 16.

TABLE 16
Doses of commercial product/ha, active ingredient in
grams/ha and volume of syrup/ha.

| | Dose | Dose | Syrupe |
|---|---|---|---|
| | (L p · | (g i · | volum |
| Treatments | c · ha⁻¹) | a · ha⁻¹) | (L · ha⁻¹) |
| 1-Witness | — | — | — |
| 2-OFA-T 0143/17* | 0.2 | 48 + 40 | 100 |
| (prothioconazole + picoxystrobin) | | | |
| 3-OFA-1 0143/17* | 0.3 | 72 + 60 | 100 |
| (prothioconazole + picoxystrobin) | | | |
| 4-OFA-1 0143/17* | 0.4 | 96 + 80 | 100 |
| (prothioconazole + picoxystrobin) | | | |
| 5-OFA-TU143/17* | 0.5 | 120 + 100 | 100 |
| (prothioconazole + picoxystrobin) | | | |
| 6-Aproach Prima** | 0.3 | 60 + 24 | 100 |
| (cyproconazole + picoxystrobin) | | | |
| 7-Fox* | 0.4 | 60 + 70 | 100 |
| (prothioconazole + trifloxystrobin) | | | |

*For treatments with Fox and OFA-T 0143/17 methylated soybean oil was added 0.25% v/v
**For Aproach Prima mineral oil was added 0.75% v/v

A CO2 pressurized costal sprayer was used, equipped with six fan-type spray tips, TXA 8001 VK, spaced 0.50 m between them, with a constant pressure of 3.0 kgf/cm² and spray volume equivalent to 100 L.ha−1, in order to obtain the best coverage in diameter and droplet density.

It was recommended the use of tips that enable the production of fine drops and obtain a uniform coverage in the aerial part of the crop and consequently the target.

After the applications, evaluations were carried out at 7 and 14 days after the first application (DA1A) and at 7, 14 and 21 days after the second application (DA2A) in order to assess the severity, productivity and phytotoxicity.

The disease severity data were used to calculate the area under the disease progress curve (AUDPC), according to the equation of Shaner and Finny (1977) and the sum of the AUDPC was used to calculate the efficiency of treatments using the equation proposed by Abbott (1925). For productivity evaluation, the values obtained were extrapolated in kilograms per hectare (kg.ha−1).

### Assessment Methods

### Description of Assessments

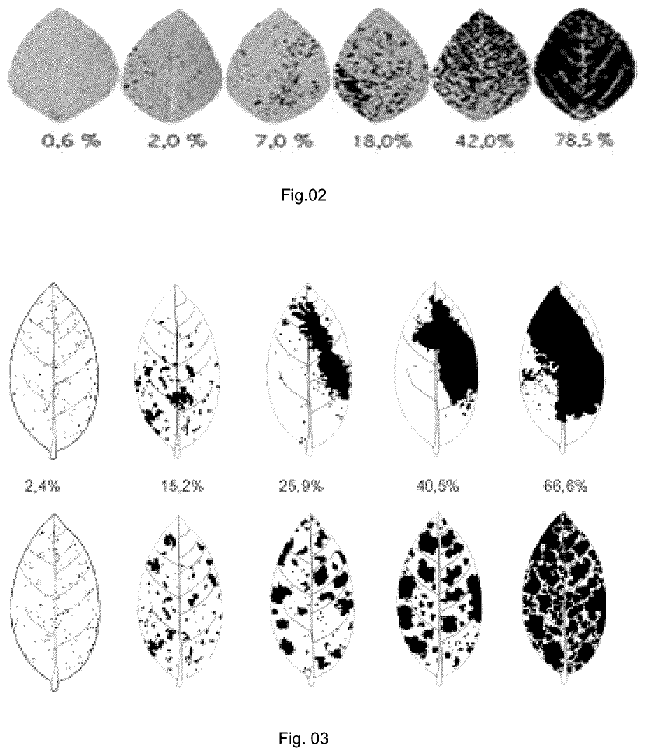

Severity for Asian rust (%): The assessment of severity in plants was performed by the visual method by assigning grades according to the diagrammatic scale adapted by Godoy et al. (2006). The grade was assigned on 20 trefoils of the middle third of the plants and the average severity per plot was calculated. FIG. 2 that describes the diagrammatic scale of soybean rust-Asian, following the scale of Godoy et al. (1997).

Severity for brown spot (%): The assessment of severity in the plants was performed by the visual method by assigning grades according to the diagrammatic scale. FIG. 3 depicts the diagrammatic scale of end-of-cycle soybean diseases (Glycine max) caused by Septoria glycines and Cercospora kikuchii. Top panel of aggregated symptoms. Lower panel of randomly distributed symptoms, following the scale of Martins et al (2004).

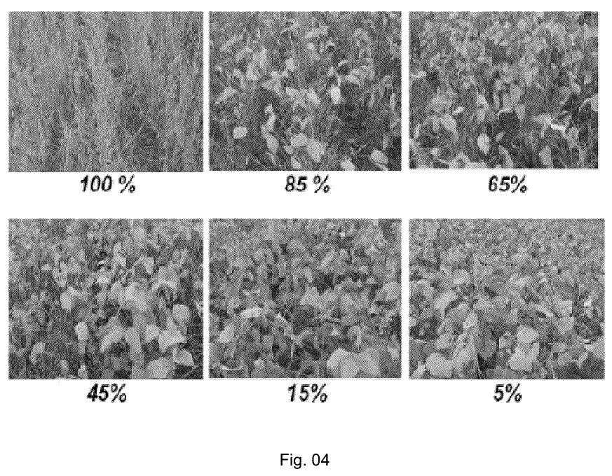

Defoliation (%): Defoliation evaluation followed the scale method proposed by Mario Hirano et al. (2010). FIG. 4 that describes the defoliation estimation scale (MARIO HIRANO et al., 2010).

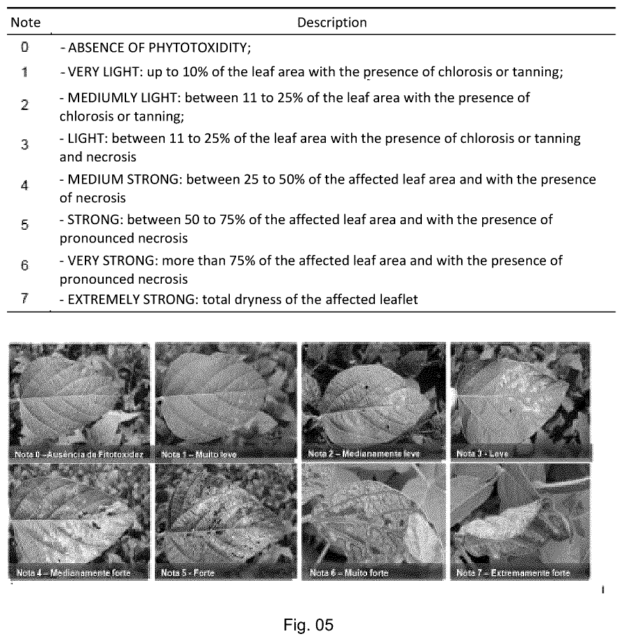

Phytotoxicity (%): For the assessment of phytotoxicity, the Campos et al. (2012). FIG. 5 depicts the diagrammatic scale for evaluating phytotoxicity as a function of tanning, chlorosis and leaf necrosis caused by the application of fungicides on soybeans, according to Campos et al. (2012).

### Rust-Asian Results and Discussion

### Severity, Area Under the Disease Progress Curve (AUDPC), Efficiency and Defoliation

The use of fungicides is one of the main tools for the management of Asian soybean rust. As it is a very aggressive disease in the crop, there is no level of economic damage adopted to control it, which must be done preventively, seeking to achieve better product performance and consequently higher levels of control.

In this context, the three studies of different locations for the Asian rust pathogen were summarized as follows in table 17.

In the assessment of severity, prior to the first application, no symptoms of infection of the fungus Phakopsora pachyrhizi were observed, thus the application occurred preventively to the incidence of the disease.

Table 17 shows the Asian rust severity data at 7 and 14 days after the first application (DA1A), and at 7, 14 and 21 days after the second application (DA2A), the area under the curve of disease progress, efficiency calculation and defoliation percentage.

Regarding the progress of Asian rust during the evaluations, it can be observed that there was good evolution for the control, as well as for treatments with fungicides, but these in smaller proportion. It was found that at 7DA1A (days after application) that the control had 5% of disease severity while the OFA treatments in the same period had an average of 1%.

At 14DA1A there was significant progress of the disease in the control treatment, doubling severity values in the absence of use of fungicides, thus justifying the reapplication of treatments within 14 days, in addition to stressing that rust Asiatic is a polycyclic fungal disease that progresses exponentially after the first infection.

After the second application at 07 days, it was found that the treatments OFA-T 0143/17 (prothioconazole+picoxystrobin) from the dose of 0.3 L.ha−1 associated with 0.25%v/v of methylated soybean oil, as well as the Fox standard (prothioconazole+trifloxystrobin) at a dose of 0.4 L.ha−1 showed the lowest values of Asian rust severity and, consequently, the best control efficiencies among the treatments with application fungicide.

This table is also maintained for the evaluations at 14 DA2A and 21 DA2A (days after the second application). For AUDPC data, the fungicide OFA-T 0143/17 (prothioconazole+picoxystrobin) showed significant differences as a function of dose variation. 0.3 OFA; 0.4 and 0.5 L.ha−1, which presented the lowest values of accumulated AUDPC, consequently efficiencies of 75.2%, 84% and 86.4% respectively in the control of Asian rust, being superior to Fox standards (prothioconazole+trifloxystrobin) associated with 0.25% of methylated soybean oil and in relation to Aproach Prima (cycronazole+picoxystrobin) associated with 0.75% v/v of mineral oil.

Regarding the defoliation parameter, treatments with OFA-T 0143/17 (prothioconazole+picoxystrobin) associated with 0.25% v/v of methylated soybean oil showed a reduction in the percentage of defoliation of soybean plants, being statistically different from control, as well as the standard treatment of Aproach Prima (cyproconazole+picoxystrobin) associated with 0.75%v/v mineral oil.

On the other hand, all treatments with OFA-T 0143/17 (prothioconazole+picoxystrobin) associated with 0.25%v/v methylated soybean oil showed no statistical difference when compared to the standard Fox treatment (prothiconazole+trifloxystrobin) associated with 0.25%v/v methylated soybean oil, even when applied at the lowest dose of OFA-T 0143/17 (prothioconazole+picoxystrobin), as shown in Table 17.

The high adaptability of P. pachyrhizi in soybean fields makes it difficult to control Asian rust. In this sense, it is important to emphasize that fungicides with combinations of two or more active ingredients with different modes of action must be complementary, that is, acting in completely different action sites in the development of the fungus.

The fungicide OFA-T 0143/17 (prothioconazole+picoxystrobin) is the fungicide that showed the best performance in the management of Asian soybean rust when compared to Aproach Prima (cyproconazole+picoxystrobin) and Fox (prothioconazole+trifloxystrobin), as can be seen in the results presented above.

The fungicide OFA-T 0143/17 contains the association of one of the fungicides DMIs (triazoles−prothioconazole) and strubirulins (picoxystrobin) more potent for the Asian soybean rust. Prothioconazole acts by inhibiting the biosynthesis of ergosterol, an important substance for the maintenance of fungal cell integrity and the interruption of mycelial growth (Hewitt, 1998).

The great effectiveness of the mechanism of action of DMIs, especially prothiconazole, is in the development of the haustorium and mycelial growth within the tissues (Buchenauer, 1987) and it is for this reason that this fungicide is attributed a potent curative action. DMIs do not efficiently affect spore germination and germ tube stage as the pathogen obtains the supply of ergosterol or its precursors from reserves contained in the spores (Hanssler & Kuck, 1987).

The fungicidal activity of strobilurins, among which picoxystrobin stands out, is linked to the ability to inhibit mitochondrial respiration by binding to the QO site of cytochrome b (Bartlett et al., 2002).

Cytochrome b is part of the bc1 complex, located in the mitochondrial membrane of the fungus and other eukaryotes. When the fungicide picoxystrobin binds, there is a blockage in the transfer of electrons between cytochrome b and cytochrome c1, changing the energy production cycle of the fungus (Bartlett et al., 2002).

Strobirulins such as picoxystrobin show high activity against spore germination and at the spore germ tube level (Leinhos et al., 1997).

This group of compounds acts in the energy synthesis of the fungus, and thus is highly effective in the phases of greater energy demand of fungus development (Bartlett et al., 2002).

The potent effect of strobilurins, among which picoxystrobin stands out, on spore germination explains the high preventive activity that these fungicides deliver (Bartlett et al., 2002).

However, fungicides also inhibit the mycelial growth of fungi, presenting curative and protective properties. Strobilurins can present control failures when positioned curatively or eradicatively, due to the lower probability of reaching the fungus's target site when in abundant mycelial growth, being essential to be associated with DMZ's fungicides (triazoles), which explains the perfect interaction between picoxystrobin and prothiconazole that constitute the fungicide OFA-T 0143/17 from Ourofino Agrociência SA

TABLE 17
Area Below the Disease Progress Curve (AUDPC), efficiency (%)
and defoliation (%) during the period of evaluations of Asian-rust in soybean crop

| | Products | $\frac{Dose p . c .}{( L / ha )}$ | 7D A1A¹ | 14D A1A | 7D A2A | 14D A2A | 21D A2A | AA CPD | Scott Knott | Efficiency (%) | Defoliation (%) | Scott Knott |
|---|---|---|---|---|---|---|---|---|---|---|---|---|
| 1 | Witness | — | 5.0 | 11.3 | 32.5 | 58.8 | 76.3 | 995.63 | a² | 0.0⁴ | 63 | a² |
| 2 | OFA-T 0143/17 | 0.2 | 1.0 | 2.9 | 6.9 | 16.3 | 37.5 | 313.58 | c | 68.5 | 24 | b |
| | (prothioconazole + | | | | | | | | | | | |
| | picoxystrobin) | | | | | | | | | | | |
| 3 | OFA-T 0143/17 | 0.3 | 1.0 | 2.3 | 5.0 | 8.8 | 37.5 | 247.03 | d | 75.2 | 16 | c |
| | (prothioconazole + | | | | | | | | | | | |
| | picoxystrobin) | | | | | | | | | | | |
| 4 | OFA-T 0143/17 | 0.4 | 0.9 | 1.1 | 5.0 | 8.8 | 15.0 | 158.98 | e | 84.0 | 15 | c |
| | (prothioconazole + | | | | | | | | | | | |
| | picoxystrobin) | | | | | | | | | | | |
| 5 | OFA-T 0143/17 | 0.5 | 1.4 | 1.5 | 2.5 | 7.5 | 13.8 | 135.28 | e | 86.4 | 20 | c |
| | (prothioconazole + | | | | | | | | | | | |
| | picoxystrobin) | | | | | | | | | | | |
| 6 | (cyproconazole + | 0.3 | 1.6 | 10.0 | 10.0 | 36.3 | 48.8 | 562.63 | b | 43.5 | 28 | b |
| | picoxystrobin) | | | | | | | | | | | |
| 7 | (prothioconazole + | 0.4 | 0.6 | 1.0 | 6.3 | 16.3 | 22.5 | 240.00 | d | 75.9 | 18 | c |

| | | |
|---|---|---|
| trifloxystrobin) | 5.58%³ | 14.14%³ |

¹DAA (days after application). ²In the columns, means followed by the same letter do not differ from each other by Scott-Knott at 5% probability. ³Data variation coefficient. ⁴Percentage of efficiency, by Abbott (1925). In the treatments with OFA-T 0143/17 and Fox, 0.25% v/v of vegetable oil was added, while in the treatment with Aproach Prima, 0.75% v/v of mineral oil was added.

### Culture Productivity

For the results of productivity used the hypothesis test (Student's t test) able to assess whether there is a significant difference between the means of production. When comparing the average yields of the OFA fungicide, assuming different variances, with the production value reached by the Fox fungicide, the treatment averages are 3436.56 kg.ha versus 3457.2Kg.ha, so it is possible to affirm that there is no significant difference between the yields, since the calculated t=0.56 is less than the two-tailed critical t=4.30 and the p-value=0.62 (62%) is greater than the adopted alpha=0. 05 or 5% so the productivity in kg.ha is the same.

However, for the scenario in which the means of the control and the standard fungicide Aproach Prima are confronted with the maximum production of OFA at a dose of 0.5 L/ha, the null hypothesis is rejected, as the p-value is less than alpha (0.05 or 5%), so the averages differ from each other.

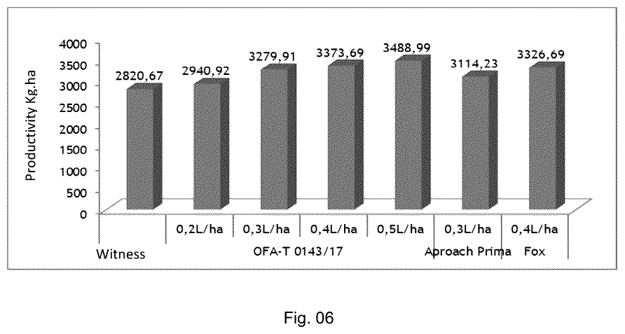

That said, it is concluded that the OFA at the different doses tested was statistically similar to the Fox standard and showed superiority in productivity compared to Aproach Prima. FIG. 6 shows the yield data of treatments in kg.ha−1.

### Phytotoxicity

It was found that the different applications and doses tested did not result in phytotoxic symptoms to soybean plants up to 14 days after the first application of the products.

After the second application, the treatments OFA-T 0143/17 (prothioconazole+picoxystrobin) at doses 0.2 and 03 L.ha−1 associated with 0.25% v/v of methylated soybean oil and the treatment with Aproach Prima (cyproconazole+picoxystrobin) at a dose of 0.3 L.ha−1 associated with 0.75% v/v continued not to show symptoms of phytotoxicity in soybean.

On the other hand, the treatments of OFA-T 0143/17 (prothioconazole+picoxystrobin) associated at doses of 0.4 and 0.5 L.ha−1 and Fox at a dose of 0.4 L ha−1, both associated with 0, 25% v/v of methylated soybean oil showed phytotoxicity in soybean plants, but classified as “mild” by the scale of Campos et al. (2012). Integrated management to be applied in the crop

For the control of Asian soybean rust, some strategies are recommended, such as, preferentially sowing early cultivars and at the beginning of the recommended period for each region; avoid extending the sowing period, as soybeans sowed later (or long cycle) will suffer greater pressure from the disease, consequently greater damage, due to the multiplication of the fungus in the first sowings (GRIGOLLI, 2015).

For chemical control, the main groups of fungicides registered are: demethylation inhibitors (DMZ's), quinone oxidase inhibitors (QoI's—striburlins), among which stand out prothioconazole, picoxystrobin and trifloxystrobin, respectively, and inhibitors of succinate dehydrogenase (SDHI's—fluxapyroxade, bixafen and benzovindiflupyr) and dithiocarbamate (mancozeb) (ZAMBOLIM, 2016).

The association of prothioconazole and picoxystrobin stand out as the main active ingredients with distinct mechanism of action (demethylation inhibitors—DMI's and quinone oxidase—QoI's—striburalins), provides a more efficient control of soybean rust, especially when in ready-made formulation containing a set of specific and recommended surfactants with 0.25%v/v methylated soybean oil, which may or may not be associated with preventive fungicides with multisite action, such as chlorothalonil or mancozeb.

Added to this is the fact that the combination of these actives in the field allows an increase in the spectrum of action of the product, ensuring it a greater residual, in addition to reducing the risk of the emergence of populations of the pathogen resistant to the fungicide (MENEGHETTI, et al 2010).

The test product of this assay, OFA-T 0143/17 (prothioconazole+picoxystrobin) at the doses tested, was efficient in controlling Asian soybean rust, highlighting doses of 0.3; 0.4 and 0.5 L.ha−1 as they resulted in better performance than the standard Aproach Prima (picoxystrobin 200+cyproconazole 80 g.L−1 SC). OFA-T 0143/2017 at a dose of 0.3 L ha−1 performed better than the Fox standard (trifloxystrobin 150+prothioconazole 175 gL−1 SC), as seen in doses of 0.4 and 0.5 L ha−1.

### Results and Discussion Brown Spot

### Severity, Area Under the Disease Progress Curve (AUDPC) and Efficiency.

Table 18 shows the area data under the disease progress and efficacy curve. The first application took place to prevent the occurrence of the disease.

Regarding the severity of brown spot during the evaluations, it can be observed that there is progress in the infectious process for the control as well as for treatments with fungicides, but these in a smaller proportion.

At 14 DA1A (days after the first application) there is an increase in disease severity which justifies the reapplication of treatments with fungicides.

The witness of 15.93 jumps to 51.19 and the OFA-T 0143/17 with the lowest accumulated value of AUDPC so far goes from 5.61 to 15.23.

After the second application at 07 days it is verified that the treatments OFA-T 0143/17 from the dose of 0.3 L.ha−1 have the lowest brown spot severity values and therefore the best effectiveness among treatments with fungicide application. This scenario is observed until 28 DA2A (days after application).

Through the sum of the AUDPC, the efficiency of the treatments was calculated using the equation proposed by Abbott, thus it appears that the OFA treatment at a dose of 0.3 L.ha−1 presented 74.4% of control, obtaining statistical superiority to the standard Aproach Prima with 68.45% of efficacy and was statistically equal to Fox at a dose of 0.4 L/ha with means of 74.3% of control.

Brown spot is one of the main diseases that occurs in the soybean crop and has caused damage to commercial crops in several Brazilian regions, reducing yields by more than 30%.

The search to find soybean cultivars resistant to S. glycines comes from three to four decades ago, but until today no cultivars with satisfactory resistance to the disease have been found. Therefore, the control of this disease is based on the application of fungicides.

Studies in different locations with different populations show that the fungicide prothioconazole has greater intrinsic activity, with ED50 values ranging from 0.000001 mg.L−1 to 0.39 mg.L−1 compared to 0.001 mg.L−1 to 3.27 mg.L−1 for cyproconazole, that is, the determined doses effective to control 50% of the disease severity are lower for the first triazole.

Thus, it is possible to state that the greater efficacy of OFA in relation to Aproach Prima, isolating the factor of the presence of picoxystrobin that both present at a dose of 0.3 L/ha in equivalent proportion of active, is directly correlated with greater activity of prothioconazole versus cyproconazole.

Throughout the harvests, the monitoring of cyproconazole for the complex of diseases in soybean was carried out and it was possible to observe a trend of increase of ED50 over the years.

Additional tests were conducted with populations with extreme values to verify the correlation of ED50 values with field efficiency and confirm this elevation in values. The same tests were installed in order to compare the most used strobilurins in soybean crops.

All estimated LD50 values were below 1 μg. mL−1, regardless of product, location and date of collection. However, the LD50 values obtained ranged from 0.012 μg mL−1 to 0.77 μg mL−1 for pyraclostrobin (mean: 0.21 μg mL−1), 0.05 μg mL−1 to 0.64 μg mL−1 for picoxystrobin (mean: 0.18 μg mL−1) and 0.0066 μg mL−1 to 0.95 μg mL−1 for azoxystrobin (mean: 0.23 μg mL−1).

Even with different methodology, the values obtained by Schmitz et al. (2014) for pyraclostrobin and azoxystrobin in 2010, were similar to those obtained in this study. That said, it can be stated that the combination of triazole with greater intrinsic activity to strobilurin with the same characteristics makes OFA-T 0143/17 (prothioconazole+picoxystrobin) an excellent tool to assist in the integrated management of diseases in the soybean crop.

TABLE 18
Area Below the Disease Progress Curve (AUDPC) during the period
of evaluations of brown spot in soybean crop and efficiency of treatments.

| No | Products | $\frac{Dose p . c .}{( L \cdot {ha}^{- 1} )}$ | 7DA1A¹ A1 | 14DA 1A | 7DA 2A | 14DA 2A | 21DA 2A | 28DA 2A | AAC PD | Scott Knott | % Efficiency |
|---|---|---|---|---|---|---|---|---|---|---|---|
| 1 | Witness | — | 15.93 | 51.19 | 95.03 | 148.31 | 212.89 | 299.04 | 822.38 | a² | — |
| 2 | OFA-T | 0.20 | 7.70 | 23.89 | 35.53 | 61.78 | 99.31 | 127.31 | 355.51 | b | 56.77⁴ |
| | 0143/17 | | | | | | | | | | |
| 3 | OFA-T | 0.30 | 5.61 | 15.23 | 20.74 | 33.4 | 50.79 | 84.68 | 210.45 | d | 74.40 |
| | 0143/17 | | | | | | | | | | |
| 4 | OFA-T | 0.40 | 6.48 | 12.51 | 16.63 | 28.09 | 52.06 | 89.69 | 205.45 | d | 75.02 |
| | 0143/17 | | | | | | | | | | |
| 5 | OFA-T | 0.50 | 6.30 | 13.74 | 19.60 | 29.05 | 43.14 | 66.94 | 178.76 | d | 78.26 |
| | 0143/17 | | | | | | | | | | |
| 6 | Aproach | 0.30 | 6.04 | 14.26 | 25.99 | 44.19 | 66.41 | 102.55 | 259.44 | c | 68.45 |
| | Prima | | | | | | | | | | |
| 7 | Fox | 0.40 | 5.80 | 14.00 | 21.80 | 33.30 | 51.00 | 85.14 | 211.04 | d | 74.34 |
| | | | | | | | | | | 7.12%³ | |

¹DAA (days after application). ²In the columns, means followed by the same letter do not differ from each other by Scott-Knott. ³Coefficient of variation of the data. ⁴Percentage of efficiency, by Abbott (1925).

### Culture Productivity

For the results of productivity used the hypothesis test (Student's t test) able to assess whether there is a significant difference between the means of production.

When comparing the average yields of the fungicide OFA, assuming different variances, of Aproach Prima it was noted that the averages are 3380.86 kg.ha−1 versus 3114.23 kg.ha−1.

Thus, we can state that there is a significant difference between the treatments, since the calculated t=4.40 is greater than the two-tailed critical t=4.30 and the p-value=0.04 (40%) is less than alpha adopted=0.05 or 5% so the productivity in Kg.ha−1 are distinct.

For the situation of comparing the OFA versus Fox means, it is possible to state that there is no significant difference between productivity, if the null hypothesis is accepted, because the calculated t=0.89 is less than the two-tailed critical t=4.30 and the p-value=0.46 (46%) is greater than the adopted alpha=0.05 or 5%. FIG. 5 shows the yield data of treatments in Kg.ha−1.

### Phytotoxicity

It was found that the different applications and doses tested did not result in phytotoxic symptoms to soybean plants up to 14 days after the first application of the products.

After the second application, the treatments OFA-T 0143/17 (prothioconazole+picoxystrobin) at doses 0.2 and 03 L.ha−1 associated with 0.25% v/v of methylated soybean oil and the treatment with Aproach Prima (cyproconazole+picoxystrobin) at a dose of 0.3 L.ha−1 associated with 0.75% v/v continued not to show symptoms of phytotoxicity in soybean.

On the other hand, the treatments of OFA-T 0143/17 (prothioconazole+picoxystrobin) associated at doses of 0.4 and 0.5 L.ha−1 and Fox at a dose of 0.4 L ha−1, both associated with 0, 25%v/v of methylated soybean oil showed phytotoxicity in soybean plants, but classified as “Light” by the scale of Campos et al. (2012).

### Integrated Management to be Applied in the Crop

The chemical control of the disease stands out among the forms of control, however, due to the survival of the fungus in the crop residues, for greater efficiency in controlling this disease, crop rotation is also recommended, accompanied by the improvement of physical conditions—soil chemistry, with emphasis on potassium fertilization (GODOY et al., 2014).

Despite the great contribution that site-specific fungicides provide in disease control, their intensive use may result in the selection of less sensitive or resistant fungal isolates (MAIS SOJA, 2016).

All soybean diseases of a fungal nature are affected by protective fungicides, the best management is always obtained with the application of these products preventively and in mixtures with specific fungicides (AZEVEDO, 2018).

The test product of the present assay OFA-T 0143/17 has two different active principles in its composition: Prothioconazole 240 g.L−1+Picoxystrobin 200 g.L−1.

There are studies in the literature with the active principles mentioned in the control of brown spot. However, its combination can become a more effective alternative to control this disease and provide resistance fighting.

The results obtained in the present trial demonstrate that OFA-T 0143/17 (Prothioconazol 240 gL−1+Picoxystrobin 200 gL−1 SC) was efficient in the control of brown spot from the dose of 0.3 L.ha−1 as they resulted in a performance statistically similar to the Aproach Prima (Picoxystrobin 200 gL−1+Cyproconazol 80 gL−1 SC) and Fox (Trifloxystrobin 150 gL−1+Prothioconazol 175 gL−1 SC) standards on AUDPC, but with a trend higher than the Approach Press.

In this way it is evidenced that the test product can become a new alternative for the management of brown spot/septoria in soybean.

### Conclusion

The fungicide OFA-T 0143/17 (Protioconazol 240 gL−1+Picoxystrobin 200 gL−1 SC) showed significantly higher gain compared to commercial standards Aproach Prima and Fox in terms of control of Asian rust (Phakopsora pachyrhizi).

The fungicide OFA-T 0143/17 (Protioconazol 240 gL−1+Picoxystrobin 200 gL−1 SC) showed significantly higher gain compared to commercial standards Aproach Prima and Fox in terms of control of brown spot (Septoria glycines).

### BIBLIOGRAPHY

ABBOTT, W. S. A method of computing the effectiveness of an insecticide. Journal of Economic Entomology, v.18, p.265-266, 1925.

AZEVEDO, L. 2018. Impact of protective fungicides on the crop. Available at: <http://maissoja.com.br/impacto-dos-fungicidas-protetores-na-cultura-da-soja/>. Accessed: Apr. 2, 2020.

BANZATTO, D. A., KRONKA, S. N. Agricultural Experimentation. 4. ed.—Jaboticabal: Funep, 2006. 237p.

Brookes, G.; Barfoot, P. GM Crops: Global Socio-economic and Environmental Impacts 1996-2015. Dorchester, UK: PG Economics Ltd, 2017. 201p.

CAMPBELL, C. L.; MADDEN, L. V. Introduction to plant disease epidemiology. 1990. 532 p.

CAMPOS, H. D.; SILVA, L. HC. P. DESCRIPTIVE AND DIAGRAMTIC SCALE FOR EVALUATION OF PHYTOTOXIDITY AS A FUNCTION OF THE INTENSITY OF CHLOROSIS AND/OR TANNING AND FOLIAR NECROSIS CAUSED BY FUNGICIDES. Rio Verde, Goias, 2p.

CANTERI, M. G., ALTHAUS, R. A., VIRGENS FILHO, J. S., GIGLIOTI, E. A., GODOY, C. V. SASM - Agri: System for analysis and separation of means in agricultural experiments by the Scott-Knott, Tukey and Duncan methods. Revista Brasileira de Agrocomputação, V.1, N.2, p. 18-24. 2001.

Colby, S. R. Calculating synergistic and antagonistic responses of herbicide combinations. Weeds, v.15, p.2022, 1967.

EIQ Calculator (Cornell, 2018; https://nysipm.cornell.edu/eiq/calculator-field-use-eiq).

EVENHUIS, A. et al. Synergy of cymoxanil and mancozeb when used to control potato late blight. Potato Research, v.39, p.551-559, 1996.

FAO. (2008). IPM Impact Assessment Series. Guidance Document No 2: Guidance on the Use of Environmental Impact Quotient in IPM Impact Assessment.

FREIRE, M. C. M. et al. Evolutionary history of Phakopsora pachyrhizi (the Asian soybean rust) in Brazil based on nucleotide sequences of the internal transcribed spacer region of the nuclear ribosomal DNA. Genetic Molecular Biology, v.31, p. 920-931, 2008.

GISI, U. et al. Synergistic interactions of fungicides with different modes of action. Transactions of the British Mycological Society, v. 85, p. 299-306, 1985.

GISI, U. Synergism between fungicides for control of Phytophthora. In: J. A. Lucas, R. C. Shattock & D. S. Shaw (Eds), Phytophthora. Cambridge University Press, Cambridge, pp. 361-372, 1991.

GODOY, C. V.; ALMEIDA, A. M. R.; SOARES, R.M.; SEIXAS, C. D. S.; DIAS, W. P.; MEYER, M. C.; COSTAMILAN, L. M.; HENNING, A. A. 2014. DISEASES OF SOYBEAN (Glycine max (L.) Merrill). Available at: <https://ainfo.cnptia.embrapa.br/digital/bitstream/item/125697/1/Doencasda Soja.pdf>. Accessed: Apr. 3, 2020.

Gowing, D.P. Comments on tests of herbicide mixtures. Weeds, v. 8, p. 379-391, 1960.

GRIGOLLI, J. F.J . 2015. Disease Management in Soybean Culture. Available at: http://www.fundacaoms.org.br/base/www/fundacaoms.org.br/media/attach ments/216/216/newarchive-216.pdf>. Accessed: Apr. 10, 2020.

KEON, J. P. R. et al. Isolation, characterization and sequence of a gene conferring resistance to the systemic fungicide carboxin from the maize smut pathogen, Ustilago maydis. Current Genetics, v. 19, p. 475-481, 1991.

Kovach, J., Petzoldt, C., Degnil, J., Tette, J. (1992). A method to measure the environmental impact of pesticides. New York's Food and Life Sciences Bulletin, 139:1-8

Lindner, K. et al. Ermittlung der Wirkeigenschaften von Phytophthora-Fungiziden fur die Epidemiesimulation. Nachrichtenblatt des Deutschen Pflan zenschutzdienstes v.46, p.205-209, 1994.

MACIEL, C. D. G. et al. Selectivity of RR soybean cultivars submitted to tank mixtures of glyphosate+chlorimuron-ethyl associated with mineral oil and insecticides. Planta Daninha, v .27, n. 4, p. 755-768, 2009.

MORE SOYBEAN. 2016. Efficiency of multi-site fungicides in controlling Asian soybean rust, Phakopsora pachyrhizi, in the 2015/16 crop year: summarized results of cooperative trials. Available at: <http://maissoja.com.br/eficiencia-de-fungicidas-multissitios-no-controle-da-ferrugem-asiatica-da-soja-phakopsora-pachyrhizi-na-safra-201516-resultados-sumarizados- dos-essays-cooperatives-2/>. Accessed: Mar. 8, 2020.

MENEGHETTI, R. C.; BALARDIN, R. S.; CUT, G. D.; FAVERA, D. D.; DEBONA, D. 2010. ACTIVATION EVALUATION Evaluation of defense activation in soybean. SOY DEFENSE ACTION AGAINST Phakopsora 823 pachyrhizi UNDER CONTROLLED CONDITIONS. Available at: <http://www.scielo.br/pdf/cagro/v34n4/v34n4a05. Accessed: Apr. 10, 2020.

Richard H. Bromilow, Chamberlain, K., & Avis A. Evans. (nineteen ninety). Physicochemical Aspects of Phloem Translocation of Herbicides. Weed Science, 38(3), 305-314.

SHANER, G. & FINNEY, R. E. The effect of nitrogen fertilization on the expression of slow-mildewing resistance in knox wheat. Phytopathology 70:1183-1186. 1977.

TREZZI, M. M. et al. Efficacy of weed control and corn toxicity of the mixture of Foramsulfuron and lodosulfuron alone or in association with Atrazine and/or Chlorpyrifos. Planta Daninha, v.23, p.653-659, 2005.

ZAMBOLIM, L. 2016. SOYBEAN RUST. Federal University of Vicosa.

WAARD, M. A. de. Synergism and antagonism in fungicides. In: H. Lyr (Ed.), Modern selective fungicides. Gustav Fischer Verlag, Jena & Longman Group (UK) Ltd, London, p.355-365, 1987.

YORINORI, J. T. et al. Epidemics of soybean rust (Phakopsora pachyrhizi) in Brazil and Paraguay from 2001 to 2003. Plant Disease, v. 89, p. 675-677, 2005.

1. A fungicidal composition for the treatment of soybean rust, comprising:
19.45 to 21.93% w/w of prothioconazole;
16.21 to 18.28% w/w of picoxystrobin;
4.00 to 10.00% w/w of propylene glycol;
a surfactant system consisting of a mixture of two compounds among (1) poly(oxy-1,2-ethanediyl), alpha-sulfo-omega-(2,4,6-tris(1-phenylethyl)phenoxy)ammonium salt, (2) methyl methacrylate-methacrylic acid methacrylate copolymer, (3) Sulphated Aromatic condensation product, sodium salt, (4) dodecanol, monoether ethoxylated with sulfuric acid, (5) polyethylene polypropylene glycol monobutyl ether, (6) polyoxyethylene tristylphenol phosphate, potassium salt, and (7) compound of triethanolamine with poly(oxyethylene) tristyrylphenol ether phosphate, where each of the compounds is in the concentration of 2.00 to 7.00% m/m;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum; and
29.00 to 56.00% m/m of water.

2. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% m/m of sulfated aromatic condensation product, sodium salt;
2.00 to 7.00% w/w of dodecanol, monoether ethoxylated with sulfuric acid;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum;
29.00 to 56.00% m/m of water.

3. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% w/w of polyethylene polypropylene glycol monobutyl ether;
2.00 to 7.00% w/w of phosphated polyoxyethylene trisylphenol, potassium salt;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum;
29.00 to 56.00% m/m of water.

4. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% w/w of polyethylene polypropylene glycol monobutyl ether;
2.00 to 7.00% w/w of triethanolamine compound with poly(oxyethylene) tristyrylphenol ether phosphate;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum; and
29.00 to 56.00% m/m of water.

5. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% w/w of poly(oxy-1,2-ethanediyl), alpha-sulfo-omega-(2,4,6-tris(1-phenylethyl)phenoxy)ammonium salt;
2.00 to 7.00% w/w of methyl methacrylate-methacrylic acid copolymer;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum; and
29.00 to 56.00% m/m of water.

6. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% w/w of dodecanol, monoether ethoxylated with sulfuric acid;
2.00 to 7.00% w/w of triethanolamine compound with poly(oxyethylene) tristyrylphenol ether phosphate;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum; and
29.00 to 56.00% m/m of water.

7. The fungicidal composition according to claim 1, comprising:
19.45 to 21.93% w/w of prothioconazole;
16.21 to 18.28% w/w of picoxystrobin;
4.00 to 10.00% w/w of propylene glycol;
2.00 to 7.00% w/w of methyl methacrylate-methacrylic acid copolymer;
2.00 to 7.00% w/w of phosphated polyoxyethylene trisylphenol, potassium salt;
0.01 to 1.00% w/w of polyvinylpyrrolidone;
0.10 to 2.00% m/m of silicon dioxide;
0.50 to 3.00% w/w of poly(dimethylsiloxane);
0.10 to 0.50% w/w of 1,2-benzisothiazolin-3-one;
0.01 to 0.30% w/w of xanthan gum;
29.00 to 56.00% m/m of water.

8. A method for treating a plant for Asian rust and brown spot, comprising treating the plant by applying the composition of claim 1 to the plant at the site of infection.
